(19) United States
(12) Patent Application Publication
(10) Pub. No.: US 2006/0184340 A1
(43) Pub. Date: Aug. 17, 2006

(54) Deterministic sampling simulation device for generating a plurality of distribution simultaneously

(75) Inventors: Ikuo Fukuda, Kawasaki (JP); Haruki Nakamura, Tsukuba (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/225,018

(22) Filed: Sep. 14, 2005

(30) Foreign Application Priority Data
Feb. 14, 2005 (JP) 2005-036901

(51) Int. Cl. G06F 17/10

(52) U.S. Cl. 703/2

(57) ABSTRACT

The trajectory of solutions is calculated by numerically integrating deterministic differential equations, and when sampling along this trajectory, it is set in such a way that a distribution obtained by combining a plurality of Tsallis distributions in which the solution of differential equations covers an energy range wider than that of a Boltzmann-Gibbs (BG) distribution can be reproduced. Several values are set to the parameter of the Tsallis distribution, and a distribution is obtained by combining Tsallis distributions each corresponding to a different parameter value. Using sampling points sampled from the trajectory obtained from the distribution obtained by combining a plurality of Tsallis distributions, the physical and chemical characteristics of a physical system according to the BG distribution can be calculated by a method of statistical mechanics.

### BACKGROUND OF THE INVENTION

1. Field of the Invention

The present invention relates to a deterministic sampling simulation device for calculating the physical and chemical characteristics of a Material.

2. Description of the Related Art

The physical and chemical characteristics of a material can be described using n coordinates x=(x₁, . . . , xₙ) and n momenta P=(p₁, . . . , pₙ), the number of which is the same as the degree of freedom of a system constituting the system. Many systems can be defined by an energy function, which is the sum of a potential energy function determined by the coordinates of N atoms being its constituting elements and a kinetic energy function calculated by momenta. Therefore, if these functions are given, the characteristics of a material can be examined by computer simulation. Thus, the supplement for an ordinary experiment, furthermore countermeasures against experimental difficulty, prediction prior to an experiment and the reduction of experiment costs by a mass/distributed process, etc. have been expected, and so a lot of research and development have been made. Particularly, a classical dynamical system represented by molecules of medicines and molecules constituting an environment in which the medicine molecules act is most focused. A typical potential energy function in such a system is as follows.

$$U ( {x}_{1} , … , {x}_{n} ) = {\sum }_{i < j} {Φ}_{ij}^{Nonbond} ( \vert {r}_{i} - {r}_{j} \vert ) + {\sum }_{m} {\sum }_{{a}_{1} , … , {a}_{m}} {Φ}_{m}^{Bond} ( {x}_{{a}_{1}} , … , {x}_{{a}_{m}} ) \qquad ( 0 )$$

The first term represents potential energy determined by the distance between atoms, and the second term is the sum of potential energy for attaining equilibrium values of bond length, bond angle, etc., among atoms in molecules.

In order to grasp physical/chemical characteristics, thermodynamic quantity expressed by the expectation value of physical quantity in a distribution represented by a Boltzmann-Gibbs (BG) distribution or the like must be calculated. As the typical thermodynamic quantities of solids, there are specific heat, elastic coefficient and the like. It is considered that as a stable three-dimensional structure taken by protein, being a biological polymer, a state with the lowest free energy based on the BG distribution is selected from a variety of three-dimensional structures that a polypeptide chain having a peculiar amino acid sequence specifying each protein can take. The chemical attraction between medicines and receptor protein is quantitatively defined by a difference in free energy between a system in which they are combined into a complex and a system in which they are separated. When calculating thermodynamic quantity by calculating the expectation value of physical quantity or calculating the three-dimensional structure of protein and the chemical attraction between medicines and acceptor protein by calculating free energy in this way, it is very important to efficiently sample states expressed by (x, p).

As a method frequently used for this state sampling, there is Monte Carlo method (MC). Its algorithm is simple, and the generalization is in progress. However, when handling a system expressed by a variety of molecules, which are main targets by this method, energy easily increases due to local displacement. Therefore, it is difficult to efficiently receive state update. In molecule dynamics (MD) method, a realistic system composed of a many molecules can also be handled. Therefore, it is preferable to sample states by the MD method. As an MD method for realizing the so-called BG distribution at constant temperature, there are Nose-Hoover (NH) method (Non-patent references 1 and 2) and its developments (Non-patent references 3 and 4).

However, the energy function of a system, whose number of degrees of freedom is high, is expressed by equation 0 or the like is generally complex and it is difficult to efficiently sample its state space by the conventional MD method. For example, it is very often trapped in a structure close to an arbitrarily selected initial structure, and structure prediction cannot be correctly done, which are the so-called local trap problem.

In Patent reference 1, attention is focused to the fact that since Tsallis distribution density (excluding a normalization factor) (Non-patent references 5 and 6) as a means for solving this problem decreases in power law against an increase of energy E as follows

$${ρ}_{Tsallis} ( x , p ) = {[ 1 - ( 1 - q ) β E ( x , p ) ]}^{\frac{1}{1 - q}} \qquad ( 1 )$$

and in the case of q>1, Tsallis distribution density decreases moderately compared with BG distribution density, which decreases exponentially as follows, it can effectively avoid local trap.
ρ_{BG}(x,p)=exp[−βE(x,p)] (2)
Tsallis distribution density represented by equation (1) is realized according to deterministic equations (Non-patent reference 7). In this case, E(x, p)=U(x)+K(p) is total energy. In the equation, U is potential energy, K is kinetic energy which can be calculated as follows (it is assumed that all masses are unity),
K(p)=½Σⱼ₌₁ⁿpⱼ²
β=1/kT, in which T and k are a parameter relevant to temperature (hereinafter called “temperature”) and Boltzmann coefficient, respectively. q is a real number parameter, and q and β are given in a range such that equation (1) can be well defined as a real number according to the domain of definition of E. The limit of q→1 becomes equal to the BG distribution density equation (2) which has been conventionally used to feature a canonical distribution. Non-patent reference 7 discloses that a physical system can be simulated using the technology of Patent reference 1. Furthermore, it is also disclosed that in even a system (Non-patent references 8 and 9) which is difficult to handle by the conventional simulation method since its state sampling ability has a limit, and in which a BG distribution cannot be correctly generated, a correct result can be efficiently obtained and that in a peptide system, the wide sampling of energy space is possible (Non-references 10 and 11).

As other MD sampling methods, there are replica exchange molecular dynamics (REMD) (Non-patent reference 12) and multicanonical molecular dynamics (MCMD) (Non-patent reference 13).

However, a so-called heuristic optimization method of such as a GA method or the like, which is not the MD method, can also effectively avoid the above-mentioned local trap.

[Non-patent reference 1] S. Nose, J. Chem. Phys., 511(1984).

[Non-patent reference 2] W. G. Hoover, Phys. Rev. A, 1695(1985).

[Non-patent reference 3] S. Nose, Prog. Theor. Phys. Suppl., 1 (1991).

[Non-patent reference 4] W. G. Hoover and B. L. Holian, Phys. Lett. A, 253 (1996) and the references therein.

[Non-patent reference 5] C. Tsallis, J. Stat. Phys., 479 (1988).

[Non-patent reference 6] C. Tsallis, Braz. J. Phys., 1 (1999); for an updated bibliography, cf. http://tsallis.cat.cbpf.br/biblio.htm.

[Non-patent reference 7] I. Fukuda and H. Nakamura, Phys. Rev. E 65 (2002) 026105.

[Non-patent reference 8] D. Kusnezov, A. Bulgac and W. Bauer, Ann. of Phys., 155 (1990).

[Non-patent reference 9] I. L'Heureux and I. Hamilton, Phys. Rev. E, 1411 (1993).

[Non-patent reference 10] I. Fukuda and H. Nakamura, Chem. Phys. Lett., 367 (2003).

[Non-patent reference 11] I. Fukuda and H. Nakamura, J. Phys. Chem. B, 4162 (2004).

[Non-patent reference 12] Y. Sugita and Y. Okamoto, Chem. Phys. Lett., 141 (1999).

[Non-patent reference 13] N. Nakajima, H. Nakamura and A. Kidera, J. Phys. Chem. B 101 (1997) 817.

[Patent reference 1] Japanese Patent Application Publication No. 2003-44524

Patent reference 1 discloses a technology for introducing a deterministic equation for generating a Tsallis distribution and capable of simulating a physical system using it. However, a problem how to calculate the parameter value of a Tsallis distribution (reference 1) for generating the most effective result is still unsolved when using this equation as a state sampling method.

In an ordinary system, this parameter must be very carefully set/selected. For example, sometimes a very little movement of the parameter value greatly changes an effectively covered energy area. Although a heuristic method or a trial-and-error method is also possible, the increase of a calculation cost cannot be avoided when a target system becomes large. Therefore, in order to aim a smoother application, a systematic method is required.

Even if the best parameter were found, a request for calculating a distribution in which further effectively wider sampling is possible cannot be easily responded.

In the REMD method, several BG distributions must be exchanged in predetermined timing with an appropriate probability. Therefore, a simulation result depends on a parameter value for determining the timing.

Although the optimization method of such as a GA method or the like, can effectively avoid the above-mentioned local trap, it generates no determined distribution in the meaning of statistical mechanics. Therefore, thermodynamic quantity cannot be directly calculated. Accordingly, it cannot be easily applied to a realistic problem, such as in-silico medicine design for estimating the chemical attraction of a new medicine with receptor protein.

### SUMMARY OF THE INVENTION

It is an object of the present invention to provide a sampling simulation device capable of conducting sampling systematically and efficiently in order to calculate the physical and chemical characteristics of a material.

The sampling simulation device of the present invention samples states, using a result obtained by numerically integrating deterministic differential equations to calculate the physical and chemical characteristics of a material. The sampling simulation device comprises a plural distribution generation unit for generating a plurality of distributions for a plurality of different parameters, with a covered energy range wider than that of a BG distribution, a numerical integration unit for numerically integrating deterministic differential equations for reproducing a distribution obtained by combining the plurality of distributions as a result of sampling along a trajectory obtained by the numerical integration and a sampling unit for sampling states along the trajectory obtained by the numerical integration.

According to the present invention, a sampling simulation device capable of systematically conducting sampling by which the physical and chemical characteristics of a complex physical system, such as medicines and proteins can be accurately calculated, can be provided.

### BRIEF DESCRIPTION OF THE DRAWINGS

FIG. 1 shows the Tsallis energy distribution of a plurality of T values.

FIG. 2 shows the BG energy distribution at 300K and a single Tsallis energy distribution P at T=19.9K.

FIG. 3 shows the potential energy distribution of each of two Tsallis potential energy distributions, the distribution of their averages and the potential energy distribution obtained by combining the two Tsallis distributions.

FIG. 4 shows each of two Tsallis distributions and their combined distribution and its BG distribution at each temperature.

FIG. 5 shows the trajectory of potential energy values obtained in this preferred embodiment.

FIG. 6 shows a result obtained by combining the Tsallis distribution of (q, ε, T₁), the Tsallis of (q, ε, T₂) and the BG distribution at 300K, using the present method.

FIG. 7 explains input data to the sampling simulation device in the preferred embodiment of the present invention.

FIG. 8 shows input data for generating a BG distribution.

FIG. 9 shows the input data of the parameter string generation unit.

FIG. 10 shows the output data in the preferred embodiment of the present invention.

FIG. 11 shows the configuration of the simulation device in the preferred embodiment of the present invention.

FIG. 12 shows the configuration of the input unit.

FIG. 13 shows the configuration and flow of the Tsallis-parameter string generation unit.

FIG. 14 shows the configuration and flow of the calculation unit.

FIG. 15 shows the configuration of the sequential output unit.

FIG. 16 shows the configuration of the final output unit.

### DESCRIPTION OF THE PREFERRED EMBODIMENTS

A method of sampling states along a trajectory obtained by numerically solving deterministic equations is applied to the preferred embodiments of the present invention. Particularly, by the simulation technology in the preferred embodiment of the present invention, this trajectory is prevented from being locally trapped and thermodynamic quantity can be calculated. The preferred embodiment of the present invention adopts a method of simultaneously generating a lot of distributions with each parameter value, instead of selecting one appropriate parameter value, and provides a method for realizing it.

Suppose that there are M target distributions and their density function ρ^{a}: R^{N}→R, a=1, . . . , M. Since it is assumed as usual that a physical system is expressed by kinetic energy K(p)≡(½)∥p∥² and potential energy U(x), ρ^{a} is made to become a density given in the following form.
ρ^{a}(ω)≡ρ^{a}(x,p,ζ)≡ρ_{P}^{a}(U(x),K(p))ρ_{z}(ζ), (3)
In this case, ρz is the appropriate real-valued function of a newly introduced real variable ζ. Therefore, the objective is to realize distribution density with the following form.
ρ(ω)≡Σₐ₌₁^{M}ρ^{a}(x,p,ζ)=Σₐ₌₁^{M}ρ_{P}^{a}(U(x),K(p))ρ_{z}(ζ)
For this purpose, the following ordinary differential equations are solved.
\dot{x}ᵢ=τ₂(x,p)pᵢ, i=1, . . . , n, (4)
\dot{p}ᵢ=−τ₁(x,p)DᵢU(x)−τ₃(ζ)pᵢ, i=1, . . . ,n, (5)
\dot{ζ}=ρ₂(x,p)∥p∥²−nT, (6)
where the following definition has been used.

$$\begin{matrix}\begin{matrix}{τ}_{α} ( x , p ) ≡ - {TD}_{α} [ ln {\sum }_{a = 1}^{M} {ρ}_{P}^{a} ] ( U ( x ) , K ( p ) ) \\ = - T \frac{{\sum }_{a = 1}^{M} {D}_{α} {ρ}_{P}^{a} ( U ( x ) , K ( p ) )}{{\sum }_{a = 1}^{M} {ρ}_{P}^{a} ( U ( x ) , K ( p ) )} , α = 1 , 2 ,\end{matrix} & ( 7 ) \\ {τ}_{3} ( ζ ) ≡ - TD ln {ρ}_{z} ( ζ ) & ( 8 )\end{matrix}$$

In this case, T is a constant with temperature dimension. T makes the dimension of each physical variable natural and determines the speed of time development of the ordinary differential equation. For convenience' sake, it is assumed that R^{N}≡R²ⁿ⁺¹≡Γ.

Next, suppose that ρ^{a} is normalized as follows.
ρ≡Σₐ₌₁^{M}\overline{ρ}^{a} with \overline{ρ}^{a}≡ρ^{a}/Z^{a}, where Z^{a}≡∫_{Γ}ρ^{a}(ω)dω
Since sometimes it is very difficult to calculate this Z^{a} in a molecular system, which is our main target, the following procedure are taken.
(a) Instead of the following equation,
ρ≡Σₐ₌₁^{M}\overline{ρ}^{a}
the following equation is used.
\tilde{ρ}≡Σₐ₌₁^{M}ρ^{a}/Y^{a} where Y^{a}≡Z^{a}/Z^{c} c is fixed one of {1, . . . , M}
(b) Y^{a} is easier to calculate than Z^{a}. As a general method to seek Y^{a}, a free energy perturbation method, a thermodynamic integration method and the like are known. Besides, a method proposed in the preferred embodiment, which is later described, can also be used.
(c) By the modification from ρ to \overline{ρ}, of equations (4) through (8), only (7) is modified as follows.

$${τ}_{α} ( x , p ) = - T \frac{{\sum }_{a = 1}^{M} {D}_{α} {ρ}_{P}^{a} ( U ( x ) , K ( p ) ) / {Y}^{a}}{{\sum }_{a = 1}^{M} {ρ}_{P}^{a} ( U ( x ) , K ( p ) ) / {Y}^{a}} , α = 1 , 2. \qquad ( 9 )$$

<Details of (b)>

In the free energy perturbation method, the thermodynamic integration method or a simple method described below, when calculating Y^{a}=Z^{a}/Z^{c}, distributions \overline{ρ}^{a} and \overline{ρ}^{c} must be sufficiently overlapped. For that purpose, firstly it is assumed that as to each a=1, . . . , M−1, \overline{ρ}^{a} and \overline{ρ}^{a+1} are placed in such a way to be sufficiently overlapped. Then, by assigning Y¹=1 (i.e. Z^{c}=Z¹), Y^{a} can be calculated as follows.
Y^{a}=Πⱼ₌₂^{a}Z^{j}/Z^{j-1} for a=2, . . . , M
As a simple method for calculating this Z^{j}/Z^{j-1}, the following equation can be used.
(P^{j-1}(E)/P^{j}(E))(ρ^{j}(E)/ρ^{j-1}(E))=Z^{j-1}/Z^{j}
In this case, P^{a} is energy distribution density obtained from ρ^{a}.

As described above, when calculating Y^{a}, overlap between distributions is important. In the Tsallis distribution [equation (1)], since a distribution is wider than that of the BG distribution, which is usually a target, overlap between distributions can be easily realized by using a plurality of Tsallis distributions, which is an advantage. Therefore, in the following example, a Tsallis distribution is used as a specific shape of the distribution ρ^{a}. In this case, equation (9) becomes as follows.

$$\begin{matrix}{τ}_{1} ( x , p ) = {τ}_{2} ( x , p ) \\ = - T \frac{{\sum }_{a = 1}^{M} D {ρ}_{E}^{a} ( E ( x , p ) ) / {Y}^{a}}{{\sum }_{a = 1}^{M} {ρ}_{E}^{a} ( E ( x , p ) ) / {Y}^{a}} \\ = - T \frac{{\sum }_{a = 1}^{M} {α}_{a} {{b}_{a} [ 1 + {α}_{a} ( E ( x , p ) + {ɛ}_{a} ) ]}^{{b}_{a} - 1} / {Y}^{a}}{{\sum }_{a = 1}^{M} {[ 1 + {α}_{a} ( E ( x , p ) + {ɛ}_{a} ) ]}^{{b}_{a}} / {Y}^{a}} .\end{matrix} \qquad ( 13 )$$

In this case, the following equation holds true.
ρ_{P}^{a}(U(x),K(p))≡ρ_{E}^{a}(E(x,p))=[1+αₐ(E(x,p)+εₐ)]^{b}^{ₐ},
where, αₐ≡(qₐ−1)/Tₐ and bₐ≡1/(1−qₐ) [or qₐ/(1−qₐ)] are assigned. εₐ is a parameter introduced to assure 1+αₐ (e+εₐ)>0 (References 2 and 3).

How to actually set εₐ, qₐ and Tₐ is described later more specifically.

If in equations (4) through (6), (8) and (13), M≡l is assigned, a single Tsallis distribution is generated. In this case, if in these equations, α₁≡(q−1)/T, b₁≡q/(1−q) and ε₁≡0 are assigned, an equation essentially the same as the following equation disclosed Patent reference 1 (the same equation as obtained by multiplying the right side of the above equation by T) can be obtained.

$$\begin{matrix}ⅆ {x}_{i} / ⅆ t = g ( x , p ) {p}_{i} , i = 1 , … , n , \\ ⅆ {p}_{i} / ⅆ t = g ( x , p ) {D}_{i} U ( x ) - τ ( ζ ) {p}_{i} , i = 1 , … , n , \\ ⅆ ζ / ⅆ t = g ( x , p ) {‖ p ‖}^{2} - n\end{matrix} \} , \\ where g ( x , p ) ≡ \frac{q / T}{1 - ( 1 - q ) E ( x , p ) / T} , τ ( ζ ) ≡ - D ln {ρ}_{z} ( ζ )$$

It is important to secure sufficient distribution width, and it does not necessarily always mean to use a Tsallis distribution. Therefore, equations (4) through (9) do not mean to use a plurality of Tsallis distributions. There are several types of Tsallis distributions other than equation (1), which can also be used.

<Operation of the Preferred Embodiment of the Present Invention>

According to Liouville theorem, it can be proved that measure \overline{p}dω is the invariant measure of the flow (of solutions in the phase space) determined by the ordinary differential equation of equations (4) through (6), (8) and (9) [or (13)]. Therefore, under appropriate mathematical conditions, according to the ergodic theorem of Birkhoff, for almost all initial values, the long-time average of the following function f exists.
∫_{Γ}|ƒ\overline{ρ}|dω<+∞
If the system is ergodic with respect to this measure, the following equation holds true.

$$\begin{matrix}{lim}_{τ -> ∞} \frac{1}{τ} {\int }_{0}^{τ} f ( ω ( t ) ) ⅆ t = {\int }_{Γ} f \tilde{ρ} ⅆ ω / {\int }_{Γ} \tilde{ρ} ⅆ ω \\ = {\int }_{Γ} f ( ω ) ρ ( ω ) ⅆ ω / {\int }_{Γ} ρ ( ω ) ⅆ ω \\ = {\int }_{Γ} f ( ω ) {\sum }_{a = 1}^{M} {ρ}^{a} ( ω ) / {Z}^{a} ⅆ ω / \\ {\int }_{Γ} {\sum }_{a = 1}^{M} {ρ}^{a} ( ω ) / {Z}^{a} ⅆ ω\end{matrix}$$

Therefore, the long-time average of f becomes equal to an expectation value in the ‘multi’ distribution.
ρ=Σₐ₌₁^{M}ρ^{a}/Z^{a}
The realization probability of an arbitrary area A can be expressed as follows

$${lim}_{τ -> ∞} \frac{1}{τ} {\int }_{0}^{τ} {χ}_{A} ( ω ( t ) ) ⅆ t = const \times {\int }_{A} ρ ( ω ) ⅆ ω$$

using the above equation and the following expression.

$${χ}_{A} \text{:} Γ -> R , ω ↦ \{ \begin{matrix}1 … ω ∈ A \\ 0 … otherwise\end{matrix}$$

Therefore, the realization probability density for state ωεΩ is proportional to a given ‘multi’ distribution ρ. These facts show that equations (4) through (6), (8) and (9) can realize a ‘multi’ distribution.
Σₐ₌₁^{M}ρ^{a}/Z^{a}

Similarly, it is proved that if potential energy distribution density corresponding to the ρ^{a} of each a is assumed to be P^{a}U(u) for each a, potential energy distribution density Pᵤ(u) becomes as follows.

$${P}_{U} ( u ) = \frac{1}{M} {\sum }_{a = 1}^{M} {P}_{U}^{a} ( u ) , \qquad ( 12 )$$

This shows that potential energy distribution density obtained by this method becomes the average of the potential energy distribution density for each a.

As to physical quantity O(x, y), which is the function of (x, y), the following equation holds true.

$$\begin{matrix}{O}^{ \_} ≡ {lim}_{ τ \to ∞} \frac{1}{ τ} {\int }_{0}^{ τ} O ( x ( t ) , p ( t ) ) ⅆ t \\ = {\int }_{Γ} O ( x , p ) ρ ( ω ) ⅆ ω / {\int }_{Γ} ρ ( ω ) ⅆ ω \\ = {\int }_{{R}^{2 n}} O ( x , p ) {ρ}_{P} ( x , p ) ⅆ x ⅆ p / {\int }_{{R}^{2 n}} {ρ}_{P} ( x , p ) ⅆ x ⅆ p ,\end{matrix}$$

where, the following equations are assigned.
ρ_{P}(x,p)≡Σₐ₌₁^{M}ρ_{P}^{a}(U(x),K(p))/Z′^{a},
Z′^{a}≡∫_{R}_{²ⁿ}ρ_{P}^{a}(U(x),K(p))dxdp
Therefore, in order to generate a BG distribution, since the following equation holds true, it is enough that the long-time average of the leftmost side is estimated.

$$\begin{matrix}\overline{O ( {ρ}_{ BG} / { \tilde{ρ}}_{P} )} / \overline{( {ρ}_{ BG} / { \tilde{ρ}}_{P} )} = \overline{O ( {ρ}_{ BG} / {ρ}_{ P} )} / {( {ρ}_{ BG} / {ρ}_{ P} )}^{─} \\ = {\int }_{{R}^{2 n}} O ( x , p ) {ρ}_{BG} ( x , p ) ⅆ x ⅆ p / \\ {\int }_{{R}^{2 n}} {ρ}_{BG} ( x , p ) ⅆ x ⅆ p\end{matrix}$$

where the following equation is used (Y^{a}=Z^{a}/Z^{c}=Z′^{a}/Z′ is used).
\tilde{ρ}_{P}(x,p)=Σₐ₌₁^{M}ρ_{P}^{a}(U(x),K(p))/Y^{a}
In this case, although ρ_{BG} is calculated according to equation (2), an inverse temperature parameter β can take an arbitrary positive value. Since a calculation with different β can also be done in parallel, one simulation can reproduce an arbitrary number of BG distributions.

In the above-mentioned method (Patent reference 1), one effective distribution ρ^{a}/Z^{a} is selected (namely, one parameter defining ρ^{a} is set). However, in this method, a lot of distributions are (simultaneously) generated as follows.
Σₐ₌₁^{M}ρ^{a}/Z^{a}
Therefore, labor of carefully selecting one parameter seeking for a distribution, which produces the best sampling result, is reduced. Furthermore, since an arbitrary number of distributions with different energy areas effectively covered can be added, the sampling of a wide area can be easily made.

In this method, since distributions are simultaneously generated, there is no need to switch several distributions in an appropriate timing. Therefore, there is no problem that simulation results depend on a parameter value set to determine the timing.

In the following example, this method is applied to a system composed of alanine peptide, AC-Ala-Ala-NMe (Ac and NMe are acetyl and N-Methyl groups, respectively). As a potential function, an AMBER force-field (References 4 and 5) is used.

The following equation
ρ_{z}(ζ)≡exp(−cζ²) with c=10⁴ (g/mol)⁻² Å⁻⁴ fs²
is used and a 5 ns simulation with T=200k is conducted.

Using the simulation of this system, the specific setting of εₐ, qₐ and Tₐ are described. Firstly, a specific value is given to εₐ and qₐ, regardless of a, and a distribution with a different Tₐ is added.

(i) It is assumed as follows
ε≡ε₁= . . . =ε_{M}=−Ũ_{inf}: negative of candidate of lower limit of U (i)

Although the lower limit cannot be exactly calculated, usually (since there is a margin), 1+(qₐ−1)(E(x,p)+εₐ)/k_{B}Tₐ>0 is assured, and density for each a (equation (1)) can be well defined. The candidate value is the minimum value of a potential energy value obtained from a pre-simulation result of (an ordinary) MD for generating a low-temperature BG distribution. In this example, Ũ_{inf}=−25 kcal/mol

is obtained from the simulation result of 50 K.

(ii) It is assumed as follows
q≡q₁= . . . =q_{M}=1+1/n
Hansmann-Okamoto (reference 6) first proposed that q=1+1/n is advantageous in sampling for a single Tsallis distribution. In this case, generally a distribution wider than that of the BG distribution can be generated. Therefore, in this preferred embodiment, this setting method is used.
(iii) As to what Ta value should be handled, it is better to calculate a specific single Tsallis distribution beforehand since the overlap between distributions must be checked after all.

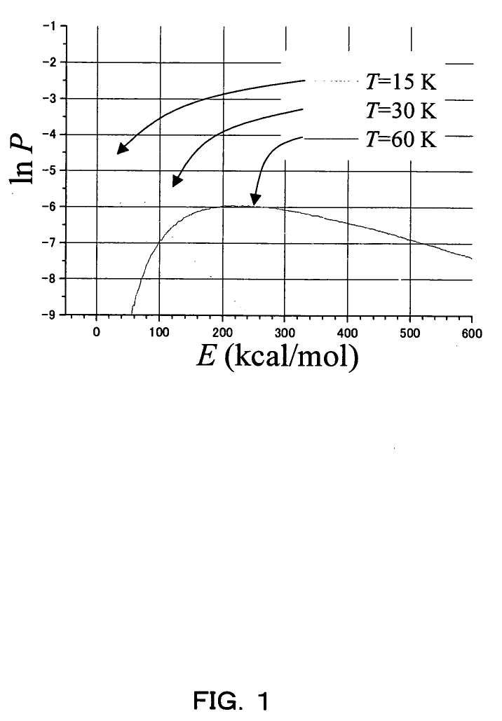

FIG. 1 shows the Tsallis energy distribution for each T value.

FIG. 1 shows the total energy distribution density of a single Tsallis distribution with several Tₐ in the settings (i) and (ii), calculated using the simulation method of Patent reference 1. It is confirmed that a distribution with Tₐ=15K and a distribution with Tₐ=60K are sufficiently overlapped, and the sum of the two distributions can cover a sufficiently wide energy area. Therefore, in this preferred embodiment, it is assumed that M=2, T₁=15K and T₂=60K.

In order to smoothly set these Ta values, the reference value of Ta described below will be useful. If a specific reference value is calculated, how Tsallis energy distribution density changes by the temperature change in the neighborhood of the reference value can be considered based on an empirical rule that a part, in which the Tsallis energy distribution density P takes large value, moves rightward as Ta increases. Although the fact is an empirical rule, it is known that an energy expectation value becomes an increasing function of T if an energy density of state is appropriately assumed, for example, Q (E)=(E−Eₘᵢₙ)^{ν} (ν is an appropriate power).

In order to determine the reference value of Tₐ, several assumptions are made. As to a BG energy distribution density PBG at temperature 1/(k_{B}β) it is assumed that 1nP_{BG} is a function concave, and P_{BG}(E₁)=P_{BG}(E₂) in energy E₁<E₂. As to a single Tsallis energy distribution density P, 1nP is also concave. In this case, if P(E₁)=P(E₂), it can be shown that the maximum value of P_{BG} and the maximum of P both exist between E₁ and E₂. This indicates that the effective support of P contains the effective support of P_{BG}. Accordingly, T at which P(E₁)=P(E₂) can be set as a reference value. It is proved that such a T is as follows.

$$T = \frac{1 - q}{{k}_{B}} \frac{( {E}_{2} + ɛ ) exp ( \frac{β}{b} {E}_{2} ) - ( {E}_{1} + ɛ ) exp ( \frac{β}{b} {E}_{1} )}{exp ( \frac{β}{b} {E}_{2} ) - exp ( \frac{β}{b} {E}_{1} )} . \qquad ( 22 )$$

Specifically, the T of equation (22) using ε and q, which are set in (i) and (ii), respectively, is specified as the reference value of Tₐ. In the example of a peptide system, a BG distribution at 1/(k_{B}β)=300K is generated using an NH method (Non-patent references 1 and 2), and E₂ is set to (energy average value+its standard deviation value) as follows.
E₂≡<E>_{BG}+σ_{BG}
Then, T=19.9K is obtained by setting E₁ in such a way that P_{BG}(E₁)=P_{BG}(E₂).

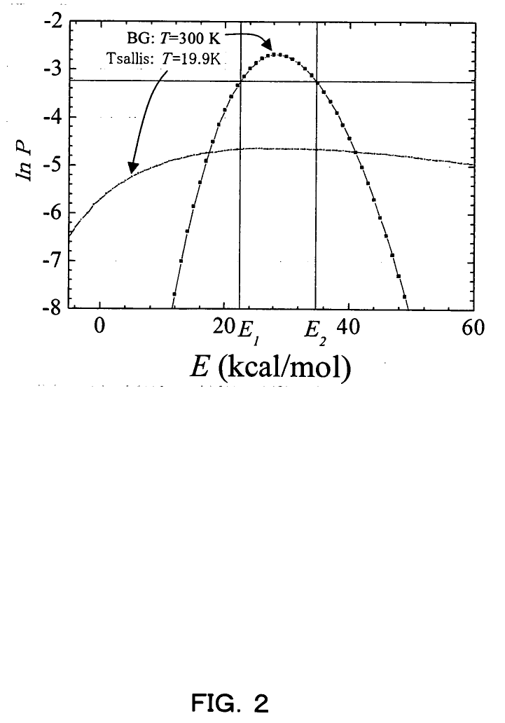

FIG. 2 shows the BG energy distribution with 300K and a single Tsallis energy distribution P with T=19.9K.

It is detected that P(E₁)=P(E₂) holds true in very close approximation, and the effective support of P sufficiently contains the effective support of P_{BG}. This verifies that the above-mentioned reference value of Tₐ is appropriately determined.

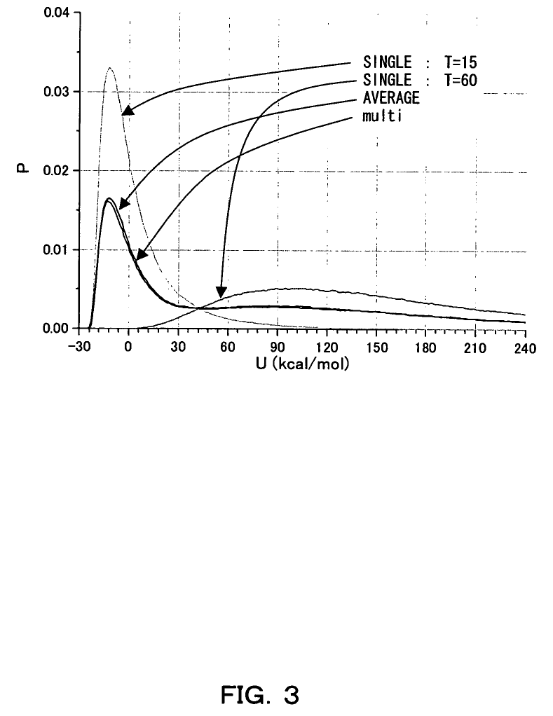

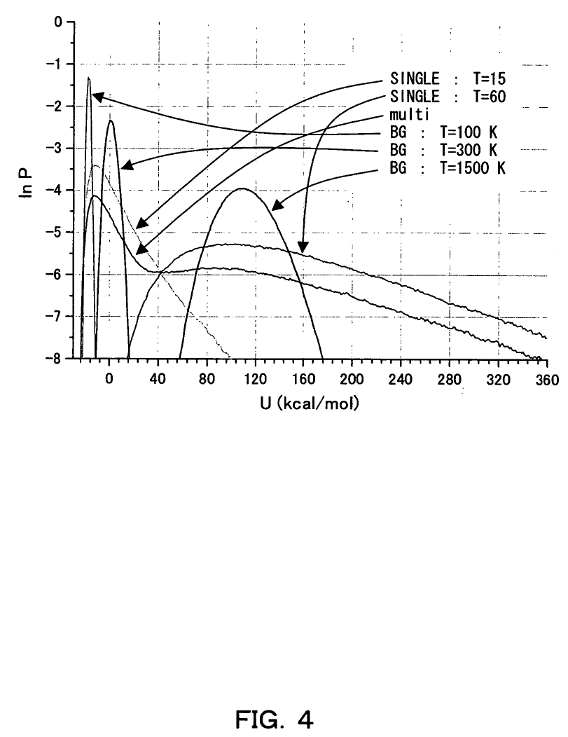

FIG. 3 shows the potential energy distribution of each of two Tsallis potential energy distributions, the distribution of their averages and the potential energy distribution (marked with ‘multi’) obtained by combining the two Tsallis distributions according to (i) through (iii). FIG. 4 shows each of two Tsallis distributions and their combined distribution and BG distribution at each temperature.

FIG. 3 shows that the combined distribution coincides with that of the average values of a single Tsallis distribution, so that equation (12) holds true. A very wide temperature area is covered (see FIG. 4). This cannot be easily covered by only a single Tsallis distribution, and is effective for sampling needed to calculate highly accurate physical and chemical characteristics.

In this preferred embodiment of the present invention, energy value is automatically exchanged among different ranges. Since in this case, exchange timing is not artificially set, there is no artifact. This point differs from the REMD method.

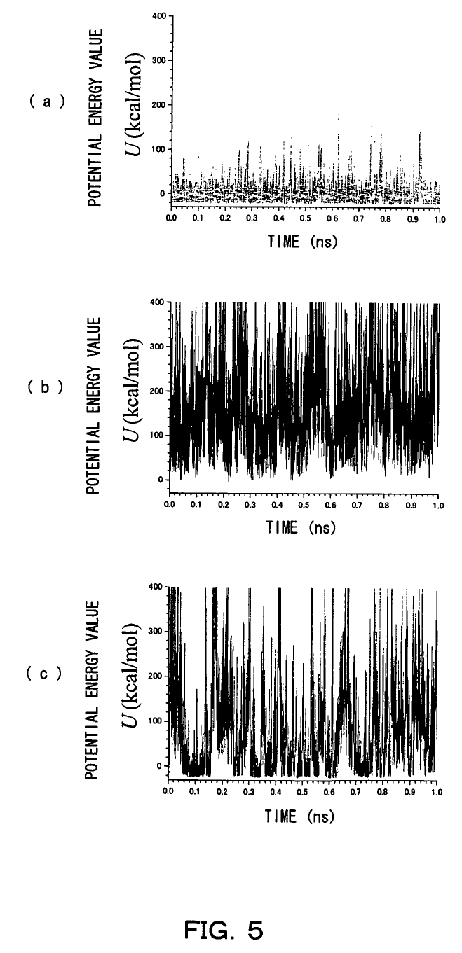

FIG. 5 shows the trajectory of potential energy values obtained in this preferred embodiment. This essentially differs from the trajectory of potential energy values obtained when generating a single Tsallis distribution. In this case, it is observed that jumps naturally occur between its main areas. Specifically, FIG. 5A shows the trajectory of the potential energy values of a single Tsallis distribution whose temperature parameter is set low, and the trajectory is localized in a part with low potential energy. FIG. 5B shows the trajectory of the potential energy values of a single Tsallis distribution whose temperature parameter is set high, and no trajectory appears in a part with low potential energy and the trajectory spreads in a part with high potential energy. FIG. 5C shows the trajectory of a distribution obtained by combining a Tsallis distribution with a high temperature parameter and one with a low temperature parameter. In this case, the trajectory spreads very widely from a part with large potential energy to one with small potential energy.

The following results are obtained when a BG distribution at 300K is added to the above-mentioned two Tsallis distributions. If a state with 300K is an actual target, such a combination method has a special effect. Specifically, in order to efficiently sample an area mainly occupied by the BG distribution with 300K, it is necessary to sample an unconnected area in phase space usually specified by a complex energy surface. For that purpose, both of an area with energy lower than the area and one with energy higher than it must be reached.

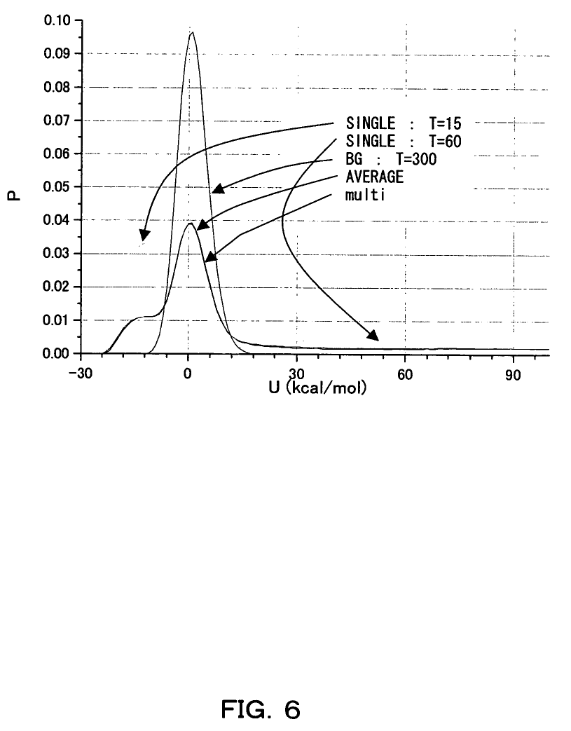

FIG. 6 shows a result obtained by combining the above-mentioned Tsallis distribution of (q, ε, T₁), the Tsallis distribution of (q, ε, T₂) and the BG distribution at 300K, using this method.

In FIG. 6, the three distributions are averaged as a result of this method. In this case, a low energy area covered by the Tsallis distribution of (q, ε, T₁), and a high energy area corresponding to (q, ε, T₂) as well as the area of the BG distribution at 300K are reached.

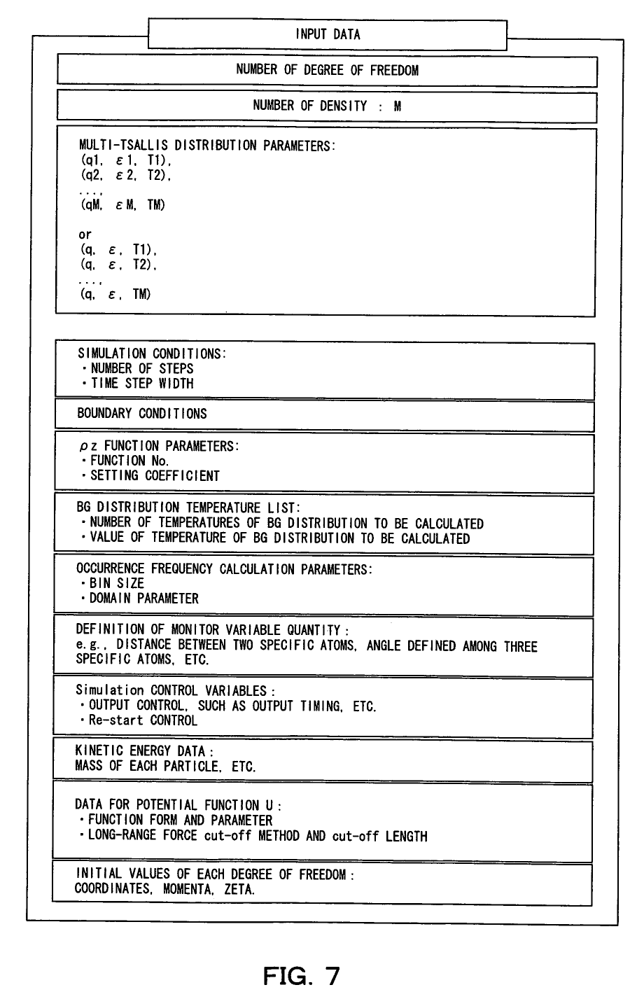

FIG. 7 explains input data to the sampling simulation device in the preferred embodiment of the present invention.

The number n is the number of degrees of freedom of a physical system to be simulated. The number of density is the number of Tsallis distributions to be combined. A multi-Tsallis distribution parameter is a parameter specifying each Tsallis distribution, and a set of (qₐ, εₐ, Tₐ) is set in each Tsallis distribution. Instead of separately setting each of these parameters, as in the above-mentioned preferred embodiment, q and ε can also be commonly set in all, and T can also be separately set in each Tsallis distribution.

Then, as simulation conditions, the number of time steps and time step width in the case where the solution of the earlier-mentioned ordinary differential equation is numerically calculated are set. Simultaneously boundary conditions are set. As the parameter of a ρz function, a function number and a setting coefficient are set. In this case, a plurality of different functions is registered in a z-density calculation unit 41, and a function to be used is selected by the function number. As the temperature list of the BG distribution, the number of the temperature of the BG distribution to be calculated and a temperature value are also set. A frequency calculating parameters, the bin size and domain parameter of the energy distribution to be calculated are set. Furthermore, as monitor variable quantities, a distance between two specific atoms, an angle defined among three specific atoms and the like are set.

As simulation control variables, variables for the output control of output timing, etc., and restart control are set. As kinetic energy data, the mass of each particle and the like are set. As the data of a potential function U, a function form/parameter, the cut-off method and cut-off length of long-range force and the like are set. As the initial values of each degree of freedom, the initial values of coordinates, momenta and ζ are set.

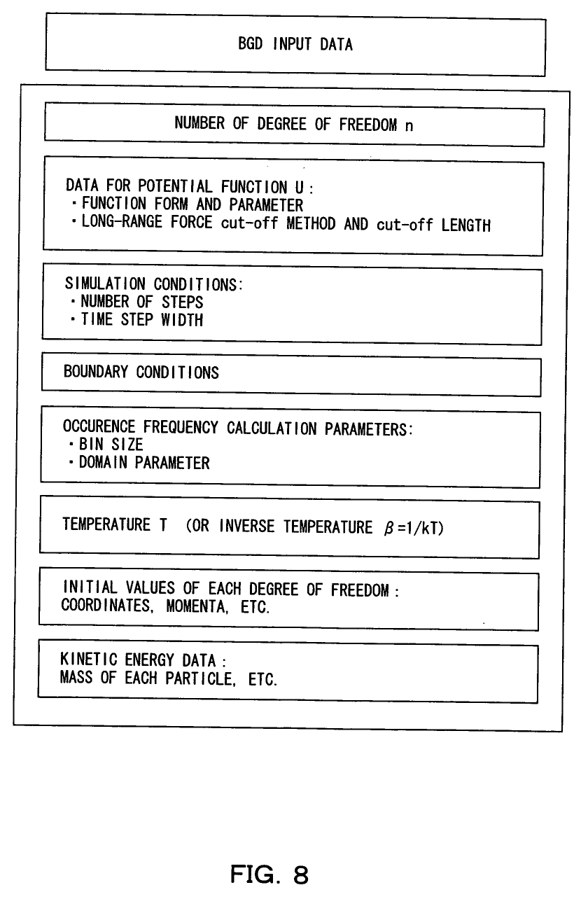

FIG. 8 shows input data for generating a BG distribution.

The number n of the degree of freedom, a function form/parameter, the cut-off method and cut-off length of long-range force as the data of a potential function U, the number of time steps, time step width and boundary conditions, being simulation conditions, bin size discreteness and a domain parameter as frequency calculating parameters, temperature T or inverse temperature β, coordinates and momenta as the initial values of each degree of freedom, the mass of each particle as kinetic energy data and the like are set.

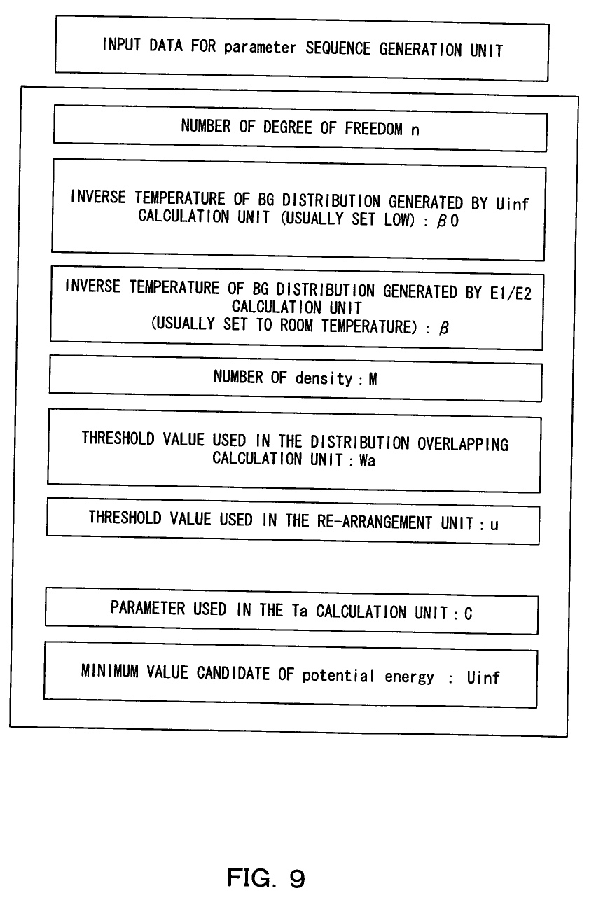

FIG. 9 shows the input data of the parameter sequence generation unit.

The number n of the degree of freedom, the inverse temperature β0 of a BG distribution usually set at low temperature, which is generated by a Uinf calculation unit described later, the inverse temperature β of the BG distribution usually set at room temperature, which is generated in an E₁/E₂ calculation unit, the number of Tsallis distributions to be generated, a threshold value Wₐ used in a distribution overlapping calculation unit, threshold value u used in a re-arrangement unit, a parameter C used in a Tₐ calculation unit and the candidate Uinf of the minimum value of potential energy are set.

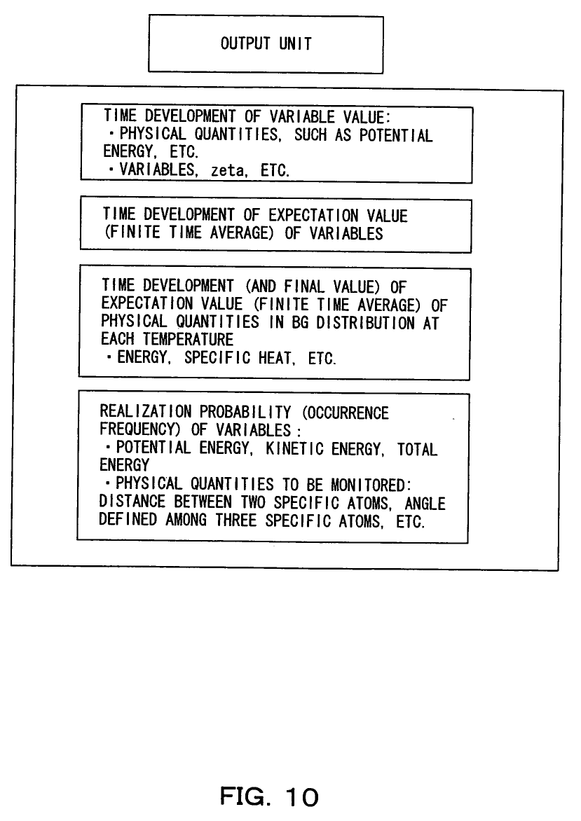

FIG. 10 shows the output data in the preferred embodiment of the present invention.

The time development of physical quantity of potential energy or the like, the time development of a variable, such as ζ, the time development of the expectation value of the variable (finite time average) or the time development of final value of the expectation value (finite time average) of physical quantity, such as energy, specific heat and the like, of the BG distribution at each temperature, and the realization probability (occurrence frequency) of potential energy, kinetic energy, the total energy, and variables, such as a distance between two specific atoms, an angle defined among three specific atoms and the like are outputted.

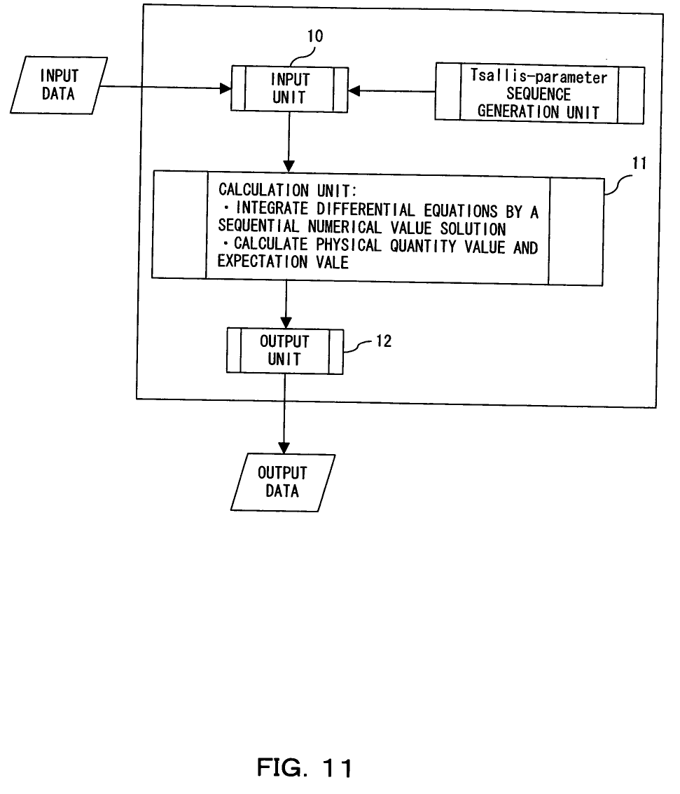

FIG. 11 shows the configuration of the simulation device in the preferred embodiment of the present invention.

To an input unit 10, input data and data from a Tsallis-parameter sequence generation unit are inputted, and are transferred to a calculation unit 11. The calculation unit 11 integrates differential equations by a sequential numeric-value solution method and calculates physical quantities and expectation values. The calculation result is outputted from an output unit 12 as output data.

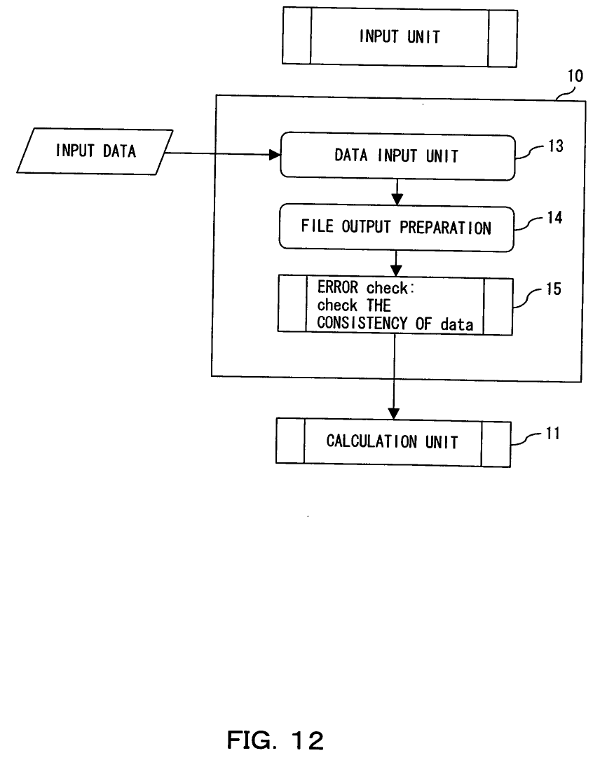

FIG. 12 shows the configuration of the input unit.

The input unit 10 receives input data by a data input unit 13 and prepares necessary files by a file output preparation unit 14. Then, the input unit 10 checks the consistency of the data by an error check unit 15 and transfers the data to the calculation unit 11.

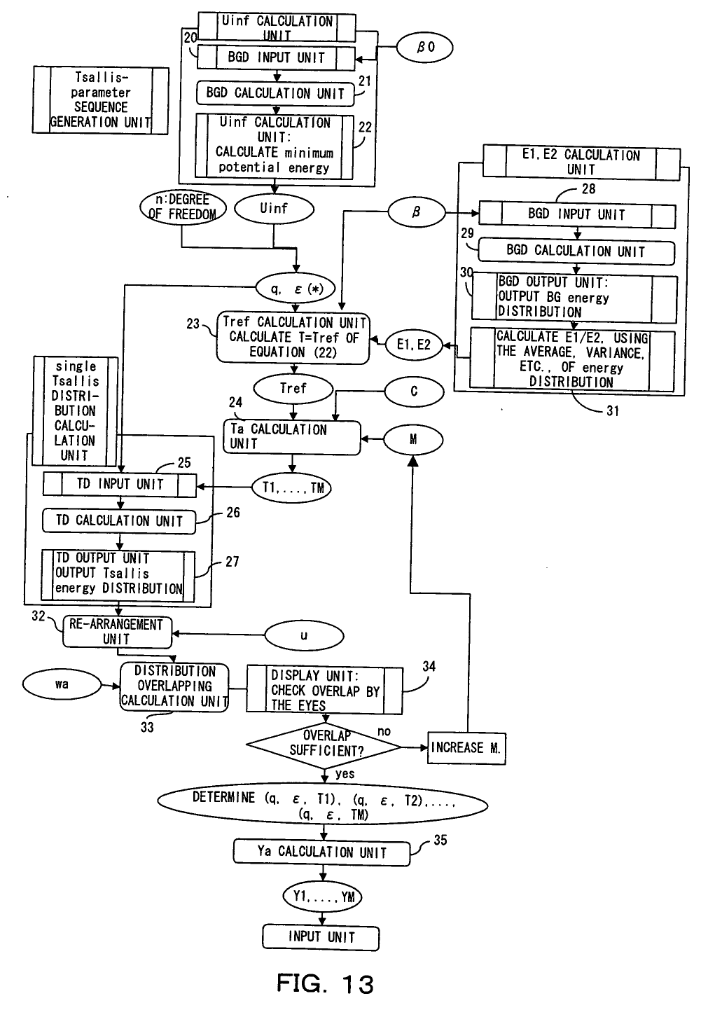

FIG. 13 shows the configuration and flow of the Tsallis-parameter sequence generation unit.

The Uinf calculation unit 22 receives the earlier-mentioned β0 by a BGD input unit 20, and conducts a simulation according to a Nose-Hoover method or the like by a BGD calculation unit 21 to generate a BG distribution. The Uinf calculation unit 22 calculates the minimum value of potential energy and specifies it as Uinf.

Uinf, the number n of the degree of freedom, and q and ε obtained in the above-mentioned (i) and (ii), respectively, are inputted to a TD input unit 25 and a Tref calculation unit 23. The earlier-mentioned β is inputted to the BGD input unit 28 of the E₁/E₂ calculation unit and the Tref calculation unit 23. The E₁/E₂ calculation unit conducts a simulation using β according to a Nose-Hoover method or the like by a BGD calculation unit 29 to generate a BG distribution, and outputs the BG energy distribution by a BGD output unit 30. Then, the E₁/E₂ calculation unit calculates E₁ and E₂ using the average, variance or the like of the energy distribution by a block 31 and inputs the result to the Tref calculation unit 23.

The Tref calculation unit 23 calculates the reference value Tref of a temperature variable according to equation (22), and a Tₐ calculation unit 24 calculates a plurality of temperature variables T₁-T_{M}, using Tref, C and M. The plurality of temperature variables is transferred to a TD input unit 25.

A TD calculation unit 26 conducts the simulation of each of the parameter values of (q₁, ε₁, T₁), . . . , (q_{M}, ε_{M}, T_{M}) inputted to the TD input unit 25, according to a Tsallis dynamics (TD) method or the like to generate a Tsallis distribution. Then, a TD output unit 27 outputs the Tsallis energy distribution. A re-arrangement unit 32 re-arranges the plurality of outputted Tsallis distributions, based on the earlier-mentioned u. Then, a distribution overlapping calculation unit 33 calculates an overlapped part, based on the earlier-mentioned Wₐ. Then, a display unit 34 displays the plurality of generated Tsallis distributions. Furthermore, a user checks the overlap of Tsallis distributions by the eyes, based on the calculated overlapped part and determines whether the overlap is sufficient. If the overlap is not sufficient, M is increased, and the Tₐ calculation unit 24 re-calculates a plurality of temperature parameters to re-calculate a Tsallis distribution. If the overlap is sufficient, a set of variables (q, ε, T) of each Tsallis distribution is determined, and a Yₐ calculation unit 35 calculates Yₐ defined by the ratio of Zᵢ. Then, Yₐ is inputted to the input unit 10.

The Tₐ calculation unit generates T₁ through T_{M}, using T=Tref as a reference value. For example, 0<C×Tref is equally (M−1)-divided and each is specified as T₁, T₂, . . . , T_{M}. In this case, C is an input value. For example, if C=2, M Tₐs equally divided using Tref as the center can be obtained.

For example, if Pₐ(E)=Pₐ₋₁ at E where there are two adjacent energy distribution values, the distribution overlapping calculation unit 33 determines whether Pₐ(E) is relatively larger in Pₐ. Similarly, it is determined whether Pₐ₋₁ (E) is relatively larger in Pₐ₋₁. This is applied to a=1˜M. For example, wₐ=Pₐ(E)/Pₐ(Eₘₐₓ) and a predetermined threshold value w are compared. For example, w is set to 0.5. Alternatively, when Pₐ(E)=P_{b}(E) at E where there are energy distribution values among all pairs of energy distributions, it can be determined whether Pₐ(E) is relatively larger in Pₐ, and if M is large, unnecessary distributions can be deleted.

The Yₐ calculation unit 35 calculates a distribution function ratio according to (Pⱼ₋₁(E)/Pⱼ(E)) (ρⱼ(E)/ρⱼ₋₁(E))=(Zⱼ₋₁/Zⱼ) and calculates Yₐ.

The re-arrangement unit 32 performs the following processes.

(i) The re-arrangement unit 32 specifies a as 1, of which the minimum value among Eₐ that is determined such that 1nPₐ(E)=u (threshold value) takes the smallest (usually among two values).

(ii) The re-arrangement unit 32 specifies Pₐ as P₂, at which a is one of {2, . . . , M} and an intersection Ea between Pₐ and P₁ is the minimum (there might be a plurality of intersections).

(iii) The re-arrangement unit 32 specifies Pₐ as P₃, at which a is one of {3, . . . , M} and an intersection Ea between Pₐ and P₂ is the minimum (there might be a plurality of intersections).

(iv) Similarly, the re-arrangement unit 32 determines P₄, . . . , P_{M}.

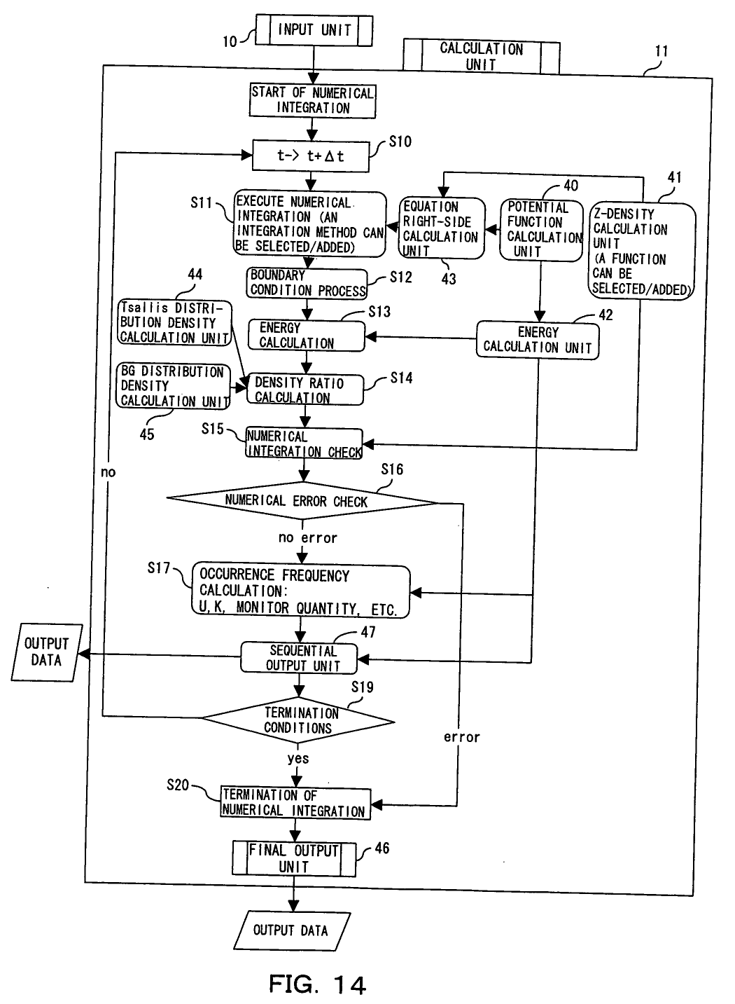

FIG. 14 shows the configuration and flow of the calculation unit.

Data is obtained from the input unit 10, and numerical integration is started. In step S10, t=t+Δt is assigned. In step S11, the numerical integration is executed. At this stage, an integration method can be selected/added. In the numerical integration, a potential function calculation unit 40 calculates the respective values of a potential function and its partial derivative, and an equation right side calculation unit 43 calculates the right side containing the potential function of an equation to be numerically integrated. At this time, a z-density calculation unit 41 calculates ρz. At this time, a function can be selected/added. This calculation result is inputted to the equation right side calculation unit 43. The calculation result of the potential function calculation unit 40 is inputted to an energy calculation unit 42 and is used to calculate energy. If the numerical integration is executed, in step S12, boundary conditions are processed. In step S13, energy is calculated. In step S14, a density ratio is calculated. In step S14, the Tsallis distribution density value and BG distribution density value calculated by a Tsallis distribution density calculation unit 44 and a BG distribution density calculation unit 45, respectively, are used. In step S15, it is determined whether the resulted numeric value of the numerical integration contains an error. If in step S16 it is determined that there is an error, the process proceeds to step S20 and the numerical integration terminates. In this case, a final output unit 46 outputs the error as output data and terminates the numerical integration. If in step S16 it is not determined that there is an error, in step S17 the number of times is calculated. Specifically, the result of the numerical value calculation is sampled, and the occurrence frequency of potential energy U, kinetic energy K, physical quantities to be monitored and the like is calculated. Then, a sequential output unit 47 sequentially outputs the calculation results as output data, and also in step S19 it determines its termination conditions. If in step S19 it is not determined that the calculation terminates, the process returns to step S10 and the calculation is continued. If in step S19 it is determined that the termination conditions are met, in step S20 the numerical integration is terminated. In this case, the final output unit 46 outputs output data and terminates the numerical value calculation.

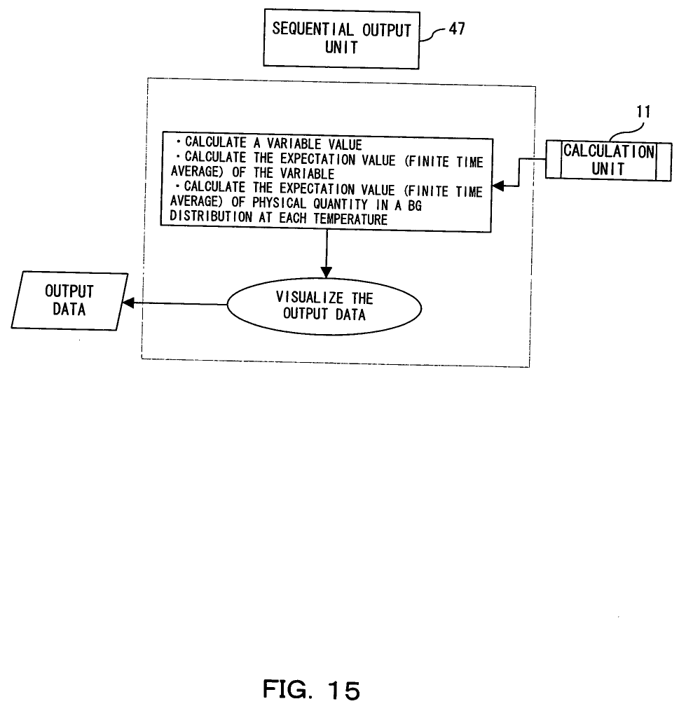

FIG. 15 shows the configuration of the sequential output unit.

Upon receipt of the calculation result from the calculation unit 11, the sequential output unit 47 calculates a variable value, the expectation value (finite time average) of the variable and the expectation value (finite time average) of physical quantity in the BG distribution at each temperature. Then, the sequential output unit 47 visualizes them and output them as output data.

The potential function calculation unit 40 calculates a potential function value and the partial derivative value of the potential function based on updated x(t), and also adds a potential function to apply a solution a restriction condition, if necessary. The potential function calculation unit 40 is configured in such a way that a function can be selected/added.

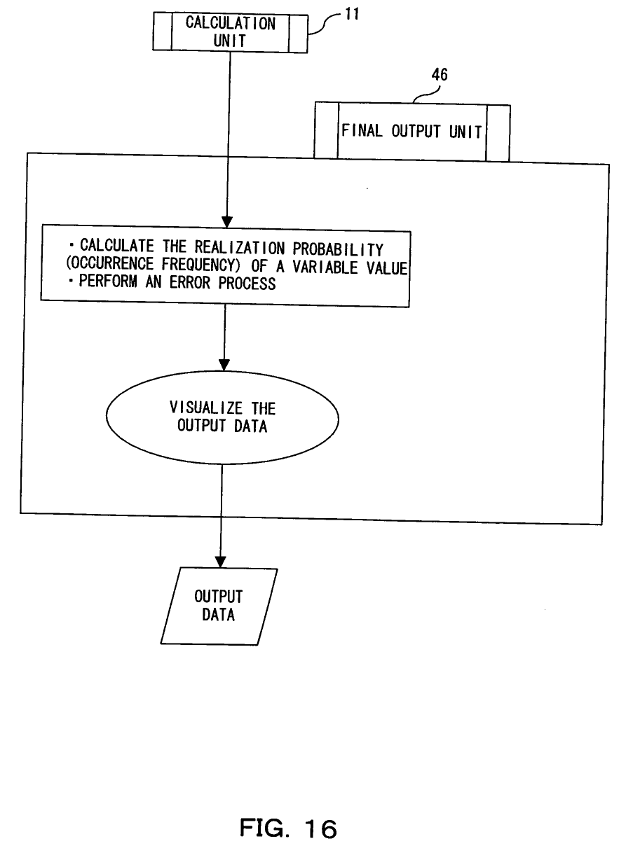

FIG. 16 shows the configuration of the final output unit.

Upon receipt of the calculation result from the calculation unit 11, the final output unit 46 calculates the realization probability (occurrence frequency) of a variable value and performs its error process. Then, the final output unit 46 visualizes it and outputs it as output data.

### REFERENCES

Reference 1: I. Fukuda and H. Nakamura, in Proceedings of the Third International Symposium on Slow Dynamics in Complex Systems, Sendai, 2003, edited by M. Tokuyama and I. Oppenheim (AIP, 2004), pp. 356-357.
Reference 2: A. R. Plastino and A. Plastino, Phys. Lett. A, 140 (1994).
Reference 3: C. Tsallis, R. S. Mendes and A. R. Plastino, Physica A, 534 (1998).
Reference 4: W. D. Cornell, P. Cieplak, C. I. Bayly, I. R. Gould, K. M. Merz, Jr., D. M. Ferguson, D. C. Spellmeyer, T. Fox, J. W. Caldwell, and P. A. Kollman, J. Am. Chem. Soc. 117 (1995) 5179.
Reference 5: P. Kollman, R. Dixon, W. Cornell, T. Fox, C. Chipot, and A. Pohorille, in: W. F. van Gunsteren, P. K. Weiner, and A. J. Wilkinson (Eds.), Computer Simulation of Biomolecular Systems, Vol. 3, Kluwer, Netherlands, 1997, pp83-96.
Reference 6: U. H. E. Hansmann and Y. Okamoto, Phys. Rev. E56 (1997) 2228.

What is claimed is:

1. A sampling simulation device for sampling using a result obtained by numerically integrating deterministic differential equations and calculating physical and chemical characteristics of a material, comprising:
a plural distribution generation unit for generating a plurality of distributions of a plurality of different parameters, with a widely covered energy range wider than that of a Boltzmann-Gibbs distribution;
a numerical integration unit for numerically integrating the deterministic differential equations for reproducing a distribution obtained by combining the plurality of distributions as a result of sampling along a trajectory obtained by the numerical integration; and
a sampling unit for sampling along the trajectory obtained by the numerical integration.

2. The sampling simulation device according to claim 1, wherein
a distribution whose energy distribution is wider than a Boltzmann-Gibbs distribution is a Tsallis distribution.

3. The sampling simulation device according to claim 1, wherein
the distributions of the plurality of different parameters are obtained by setting only a parameter corresponding to temperature to a different value.

4. The sampling simulation device according to claim 1, wherein
the combined distribution is obtained by combining a Boltzmann-Gibbs distribution and a distribution whose energy distribution is wider than a Boltzmann-Gibbs distribution.

5. The sampling simulation device according to claim 1, wherein
when it is assumed that x, p and ζ are variables, M, T and n are parameters, U is a potential energy function, K is a kinetic energy function, ρ^{a}_{P} is the wide distribution, ρz is an arbitrary distribution and Dᵢ is partial differentiation of the ith component of x, the deterministic differential equation is given by
\dot{x}ᵢ=τ₂(x,p)pᵢ, i=1, . . . , n, (4)
\dot{p}ᵢ=τ₁(x,p)DᵢU(x)−τ₃(ζ)pᵢ, i=1, . . . ,n, (5)
\dot{ζ}=ρ₂(x,p)∥p∥²−nT, (6)
where,
$$\begin{matrix}\begin{matrix}{τ}_{α} ( x , p ) ≡ - {TD}_{α} [ ln {\sum }_{a = 1}^{M} {ρ}_{P}^{a} ] ( U ( x ) , K ( p ) ) \\ = - T \frac{{\sum }_{a = 1}^{M} {D}_{α} {ρ}_{P}^{a} ( U ( x ) , K ( p ) )}{{\sum }_{a = 1}^{M} {ρ}_{P}^{a} ( U ( x ) , K ( p ) )} , α = 1 , 2 ,\end{matrix} & ( 7 ) \\ {τ}_{3} ( ζ ) ≡ - TD ln {ρ}_{z} ( ζ ) & ( 8 )\end{matrix}$$

6. The sampling simulation device according to claim 1, wherein
a reference value of a parameter corresponding to temperature of the distribution whose energy distribution is wider than a Boltzmann-Gibbs distribution is set in such a way that two energy distribution values of the wide distribution are the same in two energy values which indicate the same energy distribution value in the Boltzmann-Gibbs distribution at a desired temperature.

7. The sampling simulation device according to claim 1, which
calculates a minimum value of potential energy by calculating a Boltzmann-Gibbs distribution;
calculates a reference value of parameters corresponding to temperature of a wider energy distribution, using the Boltzmann-Gibbs distribution is calculated;
calculates a wider energy distribution of parameters corresponding to a plurality of temperatures, using the calculated minimum value and reference value;
displays the wider energy distribution of parameters corresponding to a plurality of temperatures; and
determines a distribution for calculating a normalization coefficient and calculates the normalization coefficient based on a determination result of how the energy distributions for different temperatures are overlapped using displayed distributions.

8. The sampling simulation device according to claim 1, which
numerically integrates the deterministic differential equations and samples;
processes boundary conditions;
calculates energy; and
outputs a sampling result.

9. A sampling simulation method for sampling using a result obtained by numerically integrating deterministic differential equations and calculating physical and chemical characteristics of a material, comprising:
generating a plurality of distributions of a plurality of different parameters, with a widely covered energy range wider than that of a Boltzmann-Gibbs distribution;
numerically integrating the deterministic differential equations for reproducing a distribution obtained by combining the plurality of distributions as a result of sampling along a trajectory obtained by the numerical integration; and
sampling along the trajectory obtained by the numerical integration.

10. A storage medium on which is recorded a program for enabling a computer to realize a sampling simulation method for sampling using a result obtained by numerically integrating deterministic differential equations and calculating physical and chemical characteristics of a material, the program comprising:
generating a plurality of distributions of a plurality of different parameters, with a widely covered energy range wider than that of a Boltzmann-Gibbs distribution;
numerically integrating the deterministic differential equations for reproducing a distribution obtained by combining the plurality of distributions as a result of sampling along a trajectory obtained by the numerical integration; and
sampling along the trajectory obtained by the numerical integration.
